(19) United States
(12) Patent Application Publication
(10) Pub. No.: US 2023/0046572 A1
(43) Pub. Date: Feb. 16, 2023

(54) METHOD FOR MAINTAINING OBJECT ARRANGEMENT ORDER

(71) Applicant: RELX Inc., Miamisburg, OH (US)

(72) Inventor: Peter Beukema, Miamisburg, OH (US)

(73) Assignee: RELX Inc., Miamisburg, OH (US)

(21) Appl. No.: 17/401,469

(22) Filed: Aug. 13, 2021

(51) Int. Cl. G06F 16/2457; G06F 16/9538; G06F 16/28; G06F 3/0482

(52) U.S. Cl. CPC G06F 16/24578; G06F 16/9538; G06F 16/287; G06F 3/0482

(57) ABSTRACT

A method and system for maintaining the order of arrangement of a modified object list is provided. The method includes receiving selection of an object from a first plurality of objects of an object list, wherein the object list has an order of arrangement and is included on a first digital page displayed on a user interface of a device, receiving selection of a category icon from a plurality of category icons corresponding, to a plurality of categories, wherein the plurality of category icons are included on the first digital page, modifying the object list to exclude the object from the first digital page, and maintaining the order of arrangement of the object list that is modified, wherein the maintaining includes displaying a second plurality of objects included in the object list that is modified on the first digital page in accordance with the order of arrangement.

### TECHNICAL FIELD

The present specification relates to a method of maintaining an order of arrangement of an object list, and more specifically, to excluding one or more objects from the object list and maintaining the locations of the remaining objects of the object list subsequent to the exclusion.

### BACKGROUND

Conventional techniques may organize, display, and reorder search listings, search results, links, and so forth, in various ways. For example, search engines may list search results based on relevance, chronology, language, etc., in addition to enabling users to save subject matter associated with these search results in several ways. However, conventional techniques fail to have the functionality to control the number of search results displayed on a digital page and the manner in which these results are displayed for the, purposes of enabling user-friendly browsing and review.

Accordingly, a need exists for facilitating user friendly browsing of search results, namely by controlling the number of search results that are displayed on a particular page and ensuring that at least a subset of the search results conform to an arrangement order.

### SUMMARY

In one embodiment, a method for maintaining an order of arrangement of a modified object list is provided. The method includes receiving selection of an object from a first plurality of objects of an object list, wherein the object list has an order of arrangement and is included on a first digital page displayed on a user interface of a device, receiving selection of a category icon from a plurality of category icons corresponding to a plurality of categories, wherein the plurality of category icons are included on the first digital page, displaying, responsive to the selecting of the category icon, automatically and without user intervention, the object on a second digital page corresponding to a category associated with the category icon, modifying, automatically and without user intervention, the object list to exclude the object from the first digital page, and maintaining the order of arrangement of the object list that is modified, wherein the maintaining includes displaying a second plurality of objects included in the object list, that is modified on the first digital page in accordance with the order of arrangement.

In another embodiment, non-transitory computer readable medium storing instructions that, when executed by one or more processors of a computing device, cause the computing device to: receive selection of an object from a first plurality of objects of an object list, wherein the object list has an order of arrangement and is included on a first digital page displayed on a user interface of a device, receive selection of a category icon from a plurality of category icons corresponding to a plurality of categories, wherein the plurality of category icons are included on the first digital page, display, responsive to the selecting of the category icon, automatically and without user intervention, the object on a second digital page corresponding to a category associated with the category icon, modify, automatically and without user intervention, the object list to exclude the object from the first digital page, and maintain the order of arrangement of the object list that is modified, wherein the maintaining includes displaying a second plurality of objects included in the object list that is modified on the first digital page in accordance with the order of arrangement.

In yet another embodiment, another method for maintaining an order of arrangement of a modified object list is provided. The method includes receiving selection of an object from a first plurality of objects of an object list, wherein the object list has an order of arrangement and is included on a first digital page displayed on a user interface of a device, receiving a first selection of a category icon from a plurality of category icons corresponding to a plurality of categories, wherein the plurality of category icons are included on the first digital page, displaying, responsive to the selecting of the category icon, automatically and without user intervention, the object on a second digital page corresponding to a category associated with the category icon, modifying, automatically and without user intervention, the object list to exclude the object from the first digital page, maintaining the order of arrangement of the object list that is modified, wherein the maintaining includes displaying a second plurality of objects included in. the object list that is modified on the first digital page in accordance with the order of arrangement, receiving a second selection of a second object from the second plurality of objects in the object list that is modified, the second plurality of objects included on the first digital page, and receiving a third selection of an additional category icon from the plurality of category icons.

### BRIEF DESCRIPTION OF ME DRAWINGS

These and additional features provided by the embodiments described herein will be more fully understood in view of the following detailed description, in conjunction with the drawings.

FIG. 1 schematically depicts an example implementation of the method described in the present disclosure, according to one or more embodiments described and illustrated herein;

FIG. 2 schematically depicts non-limiting components of the devices of the present disclosure, according to one or more embodiments described and illustrated herein;

FIG. 3 depicts a flow chart for maintaining an order of arrangement of an object list that may be modified one or more times, according to one or more embodiments described and illustrated herein;

FIG. 4A schematically depicts an example user interface in which an example search results page is displayed and one of the search results is selected, classified, and tagged in association with a particular category and displayed on a particular digital page, according to one or more embodiments described and illustrated herein;

FIG. 4B schematically depicts modification of the search results page after a selection of a search result, according to one or more embodiments described and illustrated herein;

FIG. 4C schematically depicts another example user interface in which an example search results page is displayed and one of the search results is selected, classified, and tagged in association with another category and displayed on another digital page, according to one or more embodiments described and illustrated herein; and

FIG. 4D schematically depicts another modification of the search results page after a selection of a search listing, according to one or more embodiments described and illustrated herein.

### DETAILED DESCRIPTION

The embodiments of the present disclosure describe a method of modifying an object list displayed on a digital page and maintaining an order of arrangement of the object list subsequent to the selection and classification of one or more objects included in the object list into various categories. As stated, conventional techniques of organizing and displaying search results on digital page, which may be implemented by search engine systems (among other systems), fail to have the functionality to control the number of search results displayed on a digital page and the manner in which these results are displayed. In particular, these techniques fail to organize and display search results on a digital page in a manner that facilitates user-friendly browsing and review of these results.

The method described in the present disclosure addresses and overcomes this deficiency. A non-limiting example operation of the method of modifying an object list as described in the present disclosure relates to a scenario in which a user inputs a query for a patent, patent application, or a printed publication, and receives a plurality of patent related search results e.g., output on a display associated with a computing device. For example, the user may receive a plurality of search results such that each search result may be a patent, a patent application, a printed publication, and so forth. Each search result may include a corresponding category section in which a plurality of user selectable icons may be included, e.g., “Relevant”, “Irrelevant”, “Possibly Relevant”, and so forth. These user selectable icons may be represented by a check symbol, an “x” symbol, a “?” symbol, and so forth.

Additionally, a user may select a search result, e.g., a patent that includes the key words input by the user. In response, in embodiments, the subject matter included in the patent may be displayed to the user on a display device, e.g., a screen of a laptop, smartphone, desktop, and so forth, associated with the user. A plurality of user selectable icons may be displayed to the user alongside the selected search result. Upon selection of one of the user selectable icons, e.g., check symbol, an “x” symbol, a “?”, the search result may be removed from the list of search results and categorized and displayed on a different digital page.

For example, after selection of the check symbol adjacent to a patent that the user considers to be relevant to a search query, the search result associated with patent may be removed from the list of search results and displayed on a digital page associated with a particular category, e.g., a “Relevant” category. The check symbol may correspond with the “Relevant” category. Upon a particular search result being removed from a list of search results displayed on a digital page, the total number of search results displayed on the page and that are visible to the user is reduced. As a result, the user may be able to more efficiently read and review the remaining search results (e.g., the remaining patents, patent applications, and so forth) displayed on a page, leading to a pleasant user experience and an efficient search results reviewing process. Moreover, the order of arrangement of the remaining search results may be maintained (e.g., remain static), which helps users better identify and review, e.g., the next most relevant search result,

In embodiments, it is noted that a user, upon clicking on a particular search result, (e.g., a patent), may be able to view portions of or the entirety of the patent. For example, the user may be able to view an abstract, claims, description, citations, legal information, and so forth of that particular patent. The user may also be able to view all of the parts of a patent application, and other printed publications. In embodiments, the user may also be able to change the category in which a search result (e.g., a patent, printed publication, etc.) is classified. For example, after a patent is classified as relevant, a user may more thoroughly review the subject matter of the patent and determine that the patent is not relevant and reclassify the patent in a different category (e.g., “Not Relevant”), by selecting an “x” icon adjacent to the patent.

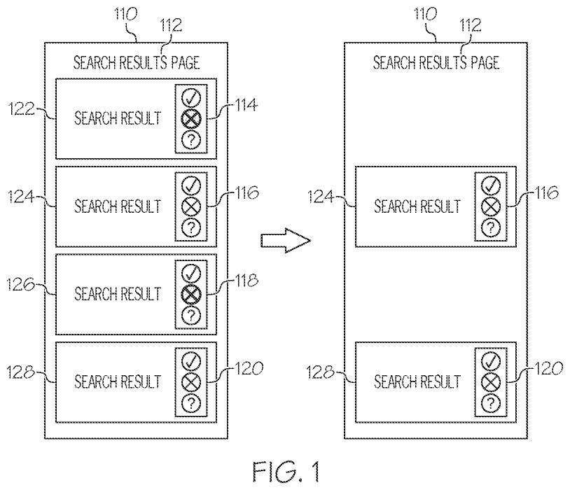

FIG. 1 schematically depicts an example implementation of the method described in the present disclosure, according to one or more embodiments described and illustrated herein. Specifically, FIG. 1 depicts an example user interface 110 that may be output on a display of a computing device 104. For example, the computing device 104 may be a laptop, a desktop, a smartphone, an Engine Control Unit (ECU) or microprocessor that is built as part of a vehicle, and so forth. The computing device 104 may also include one or more computing devices that are communicatively coupled and operable in conjunction with each other. As illustrated, FIG. 1 depicts an example search results page 112 on which a plurality of search results are listed. It is noted that the order of the search results may be such that the most relevant search result is listed at the top of the search results page 112, and each subsequent result is less relevant that the immediately preceding search result. Criteria other than relevance may also be utilized to order the list of search results on the page, e.g., chronology, alphabetical order, and so forth.

Additionally, as illustrated in FIG. 1, each of the search results 122, 124, 126 (i.e., objects), and 128 included on the search results page 112 may include category sections 114, 116, 118, and 120, adjacent to these search results. In embodiments, each of the category sections 114, 116, 118, and 120 may include a plurality of user selectable category icons that may correspond to different categories. For example, as illustrated in FIG. 1, category sections 114, 116, 118, and 120 may each include user selectable category icons represented by a check-mark symbol, an “X” symbol, a “?” symbol, and so forth. Each of these symbols may correspond with particular categories, e.g., the check symbol may correspond with a “Relevant” category, an “X” symbol may correspond with an “irrelevant” category or “Not Relevant” category, and a “?” symbol may correspond with an “Unclear” or “Partially Relevant” category, and the like. it is noted that a plurality of other types of symbols that are representative of other categories are also contemplated.

In an example implementation of method described in the present disclosure, a user may select the “X” symbol included in the category sections 114, 118 adjacent to search results 122, 126. For example, a user may determine that the search results 122, 126 are not be particularly relevant to the search query that he entered, and as such, may choose to classify and tag these search results such that these search results are displayed in and accessible from a different location (e.g., a different digital page). In embodiments, in response to the selection of the “X” symbol, the search results 122, 126 may, automatically and without user intervention, be removed from the search results page 112. In embodiments, the removed search results may be tagged and classified in a different location, e.g., a digital page that is designated to display only “irrelevant” search results. After classification, in embodiments, if a user wants to view and access the search results 122, 126, the user may input a search term into a text field and click on a “search” button. In embodiments, as part of the search, the user may select a checkbox or radio button adjacent to the term or phrase “Not Relevant” or “Irrelevant” and click the search button. In response, all of the search results that are classified and tagged in association with the “Not Relevant” category may be displayed to the user. In other words, in response to the user inputting a search term into a text field and selecting a option to only view search results under the “Not Relevant” category, the system described herein may perform a search for all of the tagged and classified search results under the “Not Relevant” category that include or are associated with the user entered search term. These search results may be displayed to the user on the page designated for the “Not Relevant” category.

After search results 122, 126 are removed from the search results page 112, the system described herein may simply list the remaining search results, e.g., search results 124, 128, in the same order in which they were previously listed. In other words, as illustrated in FIG. 1, their locations in the order of listing or arrangement of search results on the example search results on the search results page 112 may remain the same such that search result 124 may continue to be displayed at a location that is higher on the page than the location of search result 128. it is noted that the order of the search results may be configured to remain the same even if the basis upon which search results are ordered is other than relevance. In short, irrespective of the number of search results that are removed from the search results list or the criteria upon which the search results may be displayed on a particular page, the remaining search results retain their place in the order of arrangement. While a gap between search results 124, 128 is displayed in FIG. 1, in other embodiments, the search results 124, 128 may be displayed such that the search result 128 appears directly below search result 124. In other words, in other embodiments, the search results 124 and 128 may not have any gap or space between them.

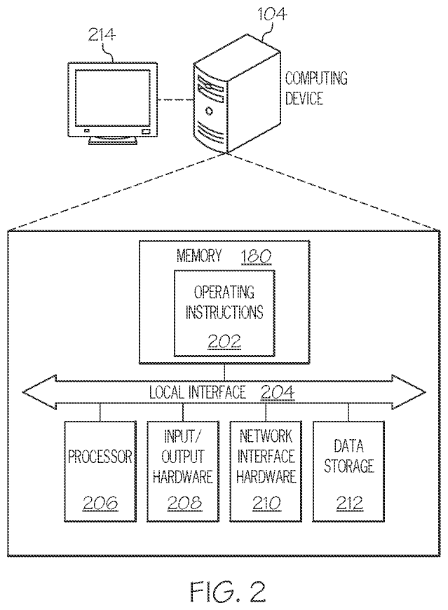

FIG. 2 schematically depicts non-limiting components of the devices of the present disclosure, according to one or more embodiments described and illustrated herein. As illustrated, the computing device 104 includes a processor 206, input/output hardware 208, a network interface hardware 210, a data storage component 212, and a memory component 180. The memory component 180 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD) (whether local or cloud-based), and/or other types of non-transitory computer-readable medium. Depending on the particular embodiment, these non-transitory computer-readable mediums may reside within the computing device 104 and/or a device that is external to the computing device 104.

The memory component 180 may store instructions 202, each of which may be embodied as a computer program, firmware, and so forth. A local interface 204 and may be implemented as a bus or other communication interface to facilitate communication among the components of the computing device 104.

The processor 206 may include any processing component operable to receive and execute instructions 202 (such as from a data storage component 212 and/or the memory component 180). As described above, the input/output hardware 208 may include and/or be configured to interface with speakers, microphones, and/or other input/output components.

The operating instructions 202 may include an operating system and/or other software for managing components of the computing device 104. It should be understood that while the components in FIG. 2 are illustrated as residing within the computing device 104, this is merely an example. In some embodiments, one or more of the components may reside external to the computing device 104 or within other devices. It should also be understood that, while the computing device 104 is illustrated as a single device, this is also merely an example. As an example, one or more of the functionalities and/or components described herein may be provided by the computing device 104. Depending on the particular embodiment, any of these devices may have similar components as those depicted in FIG. 2. To this end, any of these devices may include instructions for performing the functionality described herein.

Specifically, in embodiments, the operating instructions, when executed, perform all of the steps of the method of the present disclosure. These include receiving selections of objects from a first plurality of objects of an object list, receiving selection of a category icon from a plurality of category icons corresponding to a plurality of categories, displaying, the object on a second digital page corresponding to a category associated with the category icon, modifying the object list to exclude the object from the first digital page, and maintaining the order of arrangement of the object list that is modified. It is noted that any additional steps or different steps described in the present disclosure may also be performed upon execution of the operating instructions.

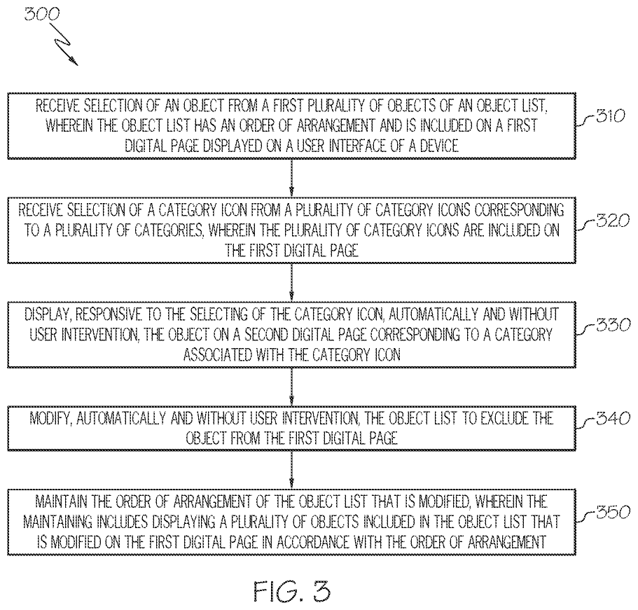

FIG. 3 schematically depicts a flow chart 300 for maintaining an order of arrangement of an object list that may be modified one or more times, according to one or more embodiments described and illustrated herein.

In block 310, the computing device 104 may receive a selection of an object from a first plurality of objects of an object list. The objects in the object list may include a plurality of search results that are provided in a particular format and according to an order of arrangement. The object list may be included, in accordance with the order or arrangement, on a first digital page that is displayed on a user interface (output on a display) of the computing device 104. The computing device 104 may be a laptop, a smartphone, a desktop, and so forth, and the first digital page may be output onto an Liquid Crystal Display (LCD) of a touch screen display, a CRT Monitor, and the like, that is part of the computing device 104 (e.g., a smartphone, tablets, and so forth), or communicatively coupled to the computing device 104 (e.g., desktop monitor, and so forth). in embodiments, the selection of the object from the first plurality of objects may be based on a user interacting with a touchscreen display associated with the computing device 104 and choosing an object from the object list. Alternatively or additionally, the computing device 104 may also receive a selection of one or more objects via user interaction with various conventional external devices (e.g., keyboard and mouse, and the like).

In an example implementation of the method described in the present disclosure, a user may access a search engine via the computing device 104 and input a search query relating to a particular topic. A non-limiting example of the search query may relate to inputting various products, services, patents, printed publications, books, and so forth. In response to the entered search query, the computing device 104 may communicate with one or more external devices (e.g., third party servers), access one or more databases, identify various search results that are pertinent to the query, and generate pertinent search results. As stated, these search results may be displayed according to a particular order of arrangement. For example, the order of arrangement may be such that the search result that is most relevant to the query is displayed at the top of the page and is followed by the next most relevant search result. In other embodiments, the search results may be arranged based on an alphabetical order, based on relevance of the titles of the search results to the search query, based on a chronological order, and so forth. An order of arrangement based on a combination of various other factors or criteria is also contemplated.

For example, as depicted in FIG. 1, search results 122, 124, 126, and 128 may be listed in a particular order from the top of the digital page to the, bottom of the first digital page (e.g., the example search results page 112). It is noted that the first digital page may refer to a main digital page, e.g., a landing page, a home page, and the like. Additionally, in embodiments, each of the search results may include a plurality of graphical representations or icons with which a user may interact. In embodiments, each of the search results and a set of user selectable icons associated with each search result may be positioned within a box designated for each search result. Various designs for the graphical representations or icons are also contemplated. In embodiments, the user selectable graphical representations or icons may be a plurality of categories icons that are associated with various categories into which the search results may be classified. As previously stated, the category icons may be displayed in the form of symbols such as “X”, “?”, “Check Mark”, and so forth. Other symbols are also contemplated. In embodiments, these categories may be indicative of the relevance of the search results to the search queries, e.g., “Relevant”, “Not Relevant”, “Partially Relevant”, and so forth. Other categories are also contemplated.

In block 320, the computing device 104 may receive a selection of a category icon from a plurality of category icons representative of categories. It is noted that the plurality of category icons are also included on the first digital page, e.g., adjacent to each of the, plurality of search results. In embodiments, after the computing device 104 receives a selection of a particular search result, a further selection of a category icon adjacent to the selected search result may be received. In particular, the user may select a symbol displayed on the user interface of the computing device 104 that is representative of the category icon, e.g., “X”, “?”, “Check Mark”, and so forth. This selection may be indicative of a user's analysis and assessment of the relevance of the search result to the search query. The search result may be associated with or linked to books, articles, patents, patent applications, printed publications, products, services, digital content in the form of videos, audios, and so forth. The selection received by the computing device 104 may be via a user interacting with a touch screen associated with the computing device 104, a keyboard, or a variety of other comparable means. Additionally, the computing device 104 may receive additional selections of category icons (symbols representative of the category icons) that are displayed adjacent to other search results.

In block 330, the computing device 104 may display, responsive to the selection of the category icon (as described in block 320), automatically and without user intervention, the object (as described in block 310) on a second digital page that corresponds to a category associated with the selected category icon (as described in block 320). For example, upon selection of a category icon or symbol representative of the “Relevant” category adjacent to a search result, the search result may be displayed on a second digital page that corresponds to the “Relevant” category. In embodiments, the second digital page may include text clearly indicating that all of the subject matter (e.g., one or more search listings) displayed on the page is associated with the “Relevant” category. The subject matter classified and tagged in association with and displayed on the second digital page may be search results that are relevant to the search query input by the user (e.g., as described under block 310). In embodiments, it is noted that the second digital page is entirely separate from the first digital page in that the second digital page may not include any of the subject matter (e.g., search listings) included on the first digital page. The second digital page (e.g., the “Relevant” category page) is designated for only storing search results that the user interprets or assesses to be relevant to a particular search query.

In another embodiment, the computing device 104 may display, responsive to the selection of the category icon (as described in block 320), automatically and without user intervention, a modified object list. For example, upon selection of the icon or symbol representative of the “Relevant” category, a modified object list may be displayed to the user such that the search result adjacent to the selected “Relevant” category may be removed from the object list and the remaining search results (e.g., other objects in the object list) may be displayed to the user in the same order of arrangement in which the objects were listed prior to the modification. It is noted that a setting or option may be selected such that, upon selection of a category icon or symbol representative of a particular category, the modified list is displayed to the user. It is further noted that, upon selection of another setting or option, a digital page designated for a particular category may be displayed to a user upon the user selecting a category icon or symbol adjacent to a search result.

In embodiments, search results included on the “Relevant” category page (e.g., the second digital page) may also include category icons in the form of symbols such as “X”, a check mark symbol, “?”, and so forth, adjacent to each of the search results listed on the “Relevant page.” In embodiments, the computing device 104 may receive another selection of a category symbol adjacent to a particular search result, including the search result that was included in the list of search results on the first digital page. For example, in embodiments, upon review and further analysis, a user may determine that a particular search result that was previously interpreted and classified as “Relevant” may not be interpreted as “Not Relevant”, As such, the computing device 104 may receive, from the user, a selection of a category icon representative of the “Not Relevant” category. In response, the search result adjacent to the selected category icon may be displayed in another digital page (e.g., a third digital page) designated for search listings (or other content) that is considered “Not Relevant”.

Additionally, as described above, in other embodiments, upon selection of a category symbol adjacent to a particular search result displayed on a page (e.g., a first digital page), a modified object list (e.g., modified list of search results) may be displayed to the user on, e.g., the first digital page. The modified list of search results would not include the particular search result as the selection of the category symbol would result in the particular search result being classified, tagged, and displayed on a digital page that is separate from the digital page on which the modified list of search results (e.g., the modified object list) is displayed. In this way, a user may efficiently be able to view the remaining search results, e.g., to determine whether or not any additional search results are relevant to his search query.

The computing device 104 may, in real time, change the categories in which search results may be classified, e.g., based on user input. Additionally, the classification of search results may be altered from one category to another, in real time, as many times as the user desires, based on the selection of the category icons. In embodiments, every search result (or other subject matter) displayed on any digital page may include category icons adjacent each search result, which facilitates efficient altering of a category in which a search result is classified, tagged, and displayed.

In block 340, the computing device 104 may modify, automatically and without user intervention, the object list to exclude the object from the first digital page. For example, a search result that is displayed in the “Relevant” category (as described in block 330) may no longer be displayed in the object list displayed on the first digital page (e.g., the main page, home page, and so forth) as described above. In other words, upon selection of a category icon adjacent to a search result (e.g., one that is associated with the “Relevant” category), that search result may be excluded, automatically and without user intervention, from the list of search results included on the first digital page by the computing device 104. Additionally, one or more search results may also be excluded from the first digital page upon selection of respective category icons adjacent to these results.

In block 350, the computing device 104 may maintain the order of arrangement of the object list that is modified. The maintaining of the object list may include displaying a second plurality of objects included in the object list that is modified on the first digital page in accordance with the order of arrangement. In embodiments, after a search result is classified under a particular category and excluded from the object list included on the first digital page (e.g., the main page, the home page, and so forth), the order of arrangement of the search results (e.g., objects in the object list) is maintained. For example, as illustrated in FIG. 1, after the search results 122 and 126 are excluded from the list of search results on the search results page 112, the location of the search results 124 and 128 are maintained. In other words, the search results 124 and 128 (as shown in FIG. 1) are displayed in the same position on the search results page 112 prior to and after the exclusion of the search results 122, 126 from the search results list.

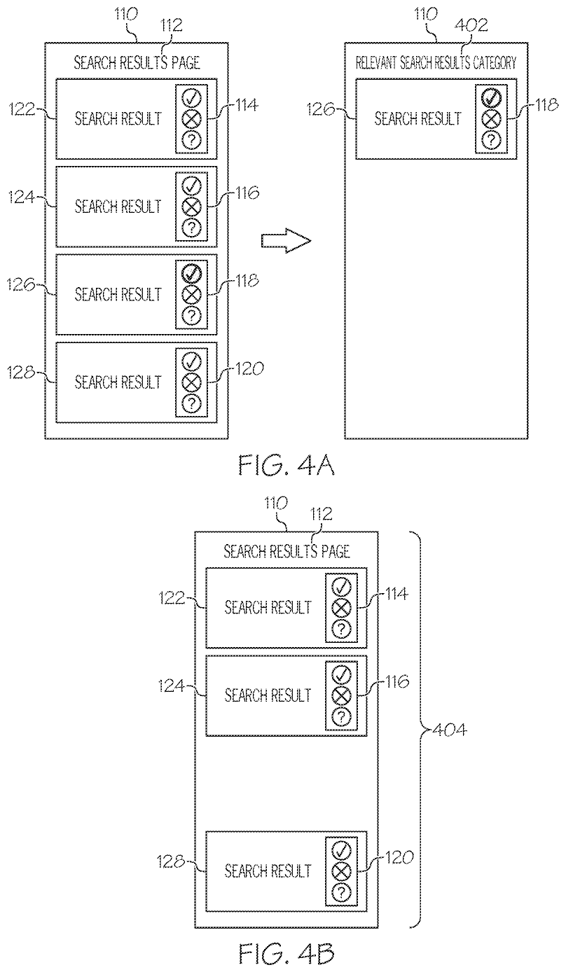

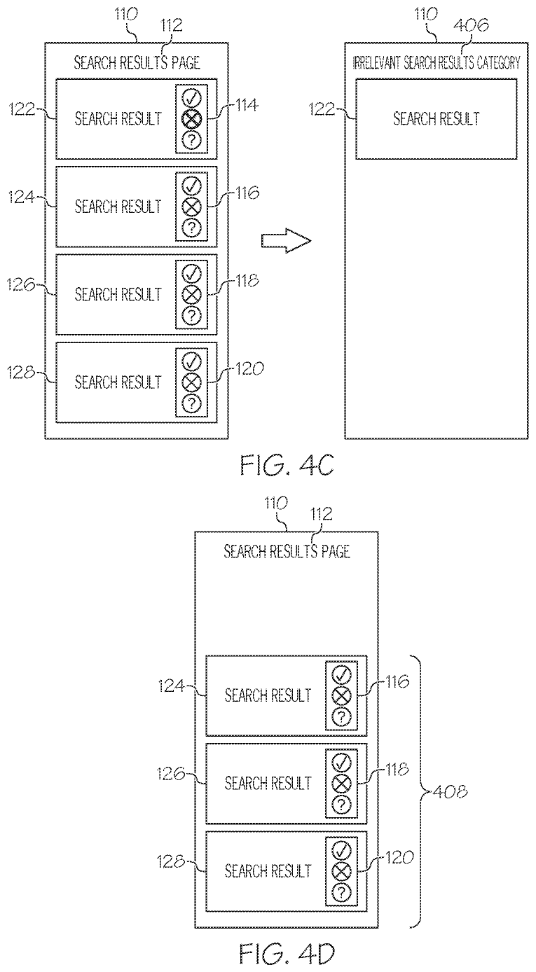

FIG. 4A schematically depicts an example user interface 110 in which an example search results page 112 is displayed and one of the search results is selected, tagged, and classified in association with a particular category, according to one or more embodiments described and illustrated herein. As stated, an example search results page 112 displayed on the example user interface 110 in FIG. 1 includes search results 122, 124, 126, 128. As illustrated, a check-mark symbol included in the category section 118 adjacent to the example search result 126 may be selected, e.g., by a user. Such a selection may be received by the computing device 104. In response to such a selection, the computing device 104 may display, automatically and without user intervention, the search result 126 on a different digital page. In embodiments, the computing device 104 may display the search result 126 on a relevant search results category digital page 402. In embodiments, the computing device 104 may associate each of the symbols included in the category section 119 with a particular category, e.g., “Relevant”, “Not Relevant”, and “Possibly Relevant”, and so forth. As such, any interaction with either of the symbols (e.g., selection of the symbols) included in category sections 114, 116, 118, 120 results in a displaying of one or more of the search results 122, 124, 126, 128 associated with these category sections in a different digital page, and a simultaneous modification of the list of objects included on the example search results page 112.

Additionally, in other embodiments, upon selection of the check-mark symbol included in the category section 118 adjacent to the example search result 126, the list of search results displayed on the search results page 112 may be modified and displayed to the user. For example, upon selection of the check-mark symbol, the example search result 126 may be removed from the list of search results displayed on the search results page 112, and the search results 122, 124, and 128 may be displayed to the user. Additionally, the search results 122, 124, and 128 that were displayed prior to the selection of the check-mark symbol adjacent to the example search result 126 would be maintained. In other words, the search result 122 may be displayed at the top of the search results page 112, and the search result 124 may be displayed directly underneath the search result 122. Thereafter, the search result 128 may be displayed directly underneath the search result 124. In this way, the order of arrangement of the list of search results displayed on the search results page 112 would be maintained prior to and after the removal of the search result 126 from the list of search results.

FIG. 4B schematically depicts modification of the search results page 112 after a selection of a search listing, according to one or more embodiments described and illustrated herein. As illustrated, FIG. 4B depicts the list of objects on the example search results page 112 that are modified after the search result 126 is excluded or removed from the list of search results (e.g., object list) and displayed on the relevant search result category digital page 402. Specifically, after the modification, the order of the search results 122, 124, and 128 are maintained according to an order of arrangement. Specifically, the order of arrangement of the search results 122, 124, 126, and 128, as illustrated in FIG. 4A, is such that search result 122 was followed immediately by search results 124, 126, and 128, respectively. It is noted that such an order of arrangement may be based on relevance of these search results to search terms that may be input by a user. It is further noted that the order of arrangement may be based on other criteria or relationships between the search terms and the search results.

While FIG. 4B illustrates a gap between search result 124 and search result 128—a space in which search result 126 was previously displayed—such a space may be removed after the object list displayed in FIG. 4A is modified. In other words, the list of search results may be arranged such that search results 124 and 128 are displayed immediately below the search result 122. In particular, the location of the search results 122, 124, and 128 are maintained. In this way, the object list 404 that includes the search results 122, 124, and 128 maintains the same order of arrangement as in FIG. 4A.

FIG. 4C schematically depicts another example user interface 110 in which an example search results page 112 is displayed and one of the search results is selected, classified, and tagged in another category, according to one or more embodiments described and illustrated herein. Specifically, FIG. 4C depicts a selection of a “X” included in the category section 114 adjacent to the search result 122, as a result of which the search result 126 is displayed on example irrelevant search results category digital page 406.

FIG. 4D schematically depicts another modification of the search results page 112 after a selection of a search listing, according to one or more embodiments described and illustrated herein. Specifically, FIG. 413 depicts a modified example object list 408 in which the search result 122 is excluded and the order of the remaining search results is maintained. In other words, search results 124, 126, 128 are displayed on the example search results page 112 such that their respective positions prior to and after the exclusion of search result 122 is maintained.

It should be understood that certain embodiments described herein are directed to a method for maintaining an order of arrangement of a modified object list. The method includes receiving selection of an object from a first plurality of objects of an object list, wherein the object list has an order of arrangement and is included on a first digital page displayed on a user interface of a device, receiving selection of a category icon from a plurality of category icons corresponding to a plurality of categories, wherein the plurality of category icons are included on the first digital page, displaying, responsive to the selecting of the category icon, automatically and without user intervention, the object on a second digital page corresponding to a category associated with the category icon, modifying, automatically and without user intervention, the object list to exclude the object from the first digital page, and maintaining the order of arrangement of the object list that is modified, wherein the maintaining includes displaying a second plurality of objects included in the object list that is modified on the first digital page in accordance with the order of arrangement.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. it is therefore intended that the appended claims cover all such changes and modifications that are within the scope of the claimed subject matter.

What is claimed is:

1. A method comprising:
receiving selection of an object from a first plurality of objects of an object list, wherein the object list has an order of arrangement and is included on a first digital page displayed on a user interface of a device;
receiving an additional selection of a category icon from a plurality of category icons corresponding to a plurality of categories, wherein the plurality of category icons are included on the first digital page;
modifying, automatically and without user intervention, the object list to exclude the object from the first digital page; and
maintaining the order of arrangement of the object list that is modified, wherein the maintaining includes displaying a second plurality of objects included in the object list that is modified on the first digital page in accordance with the order of arrangement.

2. The method of claim 1, wherein the plurality of categories include a relevant category, an irrelevant category, and a possibly relevant category. The method of claim 1, further comprising:
displaying, responsive to the selecting of the category icon, automatically and without user intervention, the object on a second digital page corresponding to a category associated with the category icon;
receiving an additional selection of an additional object from the second plurality of objects in the object list that is modified, the second plurality of objects included on the first digital page; and
receiving an additional selection of an additional category icon from the plurality of category icons.

4. The method of claim 3, further comprising further modifying the object list that is modified, the further modifying comprising excluding the additional object included in the second plurality of objects included on the first digital page.

5. The method of claim 4, further comprising further maintaining the order of arrangement of the object list that is further modified, the further maintaining including displaying in accordance with the order of arrangement, on the first digital page, a third plurality of objects in the object list that is further modified.

6. The method of claim 3, further comprising:
receiving an additional selection of the object that is displayed on the second digital page corresponding to the category; and
selecting an additional category icon corresponding to an additional category of the plurality of categories, the additional category icon is displayed on the second digital page,

7. The method of claim 6, further comprising modifying, automatically and without user intervention, the second digital page to exclude the object.

8. The method of claim 6, further comprising displaying responsive to the selecting of the additional category icon, automatically and without user intervention, the object on a third digital page corresponding to the additional category of the plurality of categories.

9. A non-transitory computer readable medium storing instructions that, when executed by one or more processors of a computing device, cause the computing device to:
receive selection of an object from a first plurality of objects of an object list, wherein the object list has an order of arrangement and is included on a first digital page displayed on a user interface of a device;
receive an additional selection of a category icon from a plurality of category icons corresponding to a plurality of categories, wherein the plurality of category icons are included on the first digital page;
modify, automatically and without user intervention, the object list to exclude the object from the first digital page; and
maintain the order of arrangement of the object list that is modified, wherein the maintaining includes displaying a second plurality of objects included in the object list that is modified on the first digital page in accordance with the order of arrangement.

10. The non-transitory computer readable medium of claim 9, wherein the plurality of categories include a relevant category, an irrelevant category, and a possibly relevant category.

11. The non-transitory computer readable medium of claim 9, wherein the non-transitory computer readable medium storing instructions, when executed by the one or more processors of the computing device, further cause the computing device to:
display, responsive to the selecting of the category icon, automatically and without user intervention, the object on a second digital page corresponding to a category associated with the category icon;
receive an additional selection of an additional object from the second plurality of objects in the object list that is modified, the second plurality of objects included on the first digital page; and
select an additional category icon from the plurality of category icons included on the first digital page.

12. The non-transitory computer readable medium of claim 11, wherein the non-transitory computer readable medium storing instructions, when executed by the one or more processors of the computing device, further cause the computing device to further modify the object list that is modified, the further modifying comprising excluding the additional object including in the second plurality of objects included on the first digital page.

13. The non-transitory computer readable medium of claim 12, wherein the non-transitory computer readable medium storing instructions, when executed by the one or more processors of the computing device, further cause the computing device to further maintain the order of arrangement of the object list that is further modified, the further maintaining including displaying in accordance with the order of arrangement, on the first digital page, a third plurality of objects in the object list that is further modified.

14. The non-transitory computer readable medium of claim I 1, wherein the non-transitory computer readable medium storing instructions, when executed by the one or more processors of the computing device, further cause the computing device to:
receive an additional selection of the object that is displayed on the second digital page corresponding to the category; and
select an additional category icon corresponding to an additional category of the plurality of categories, the additional category icon is displayed on the second digital page.

15. The non-transitory computer readable medium of claim 14, wherein the non-transitory computer readable medium storing instructions, when executed by the one or more processors of the computing device, further cause the computing device to further modify, automatically and without user intervention, the second digital page to exclude the object.

16. The non-transitory computer readable medium of claim 14. wherein the non-transitory computer readable medium storing instructions, when executed by the one or more processors of the computing device, further cause the computing device to display, responsive to the selecting of the additional category icon, automatically and without user intervention, the object on a third digital page corresponding to the additional category of the plurality of categories.

17. A method comprising:
receiving selection of an object from a first plurality of objects of an object list, wherein the object list has an order of arrangement and is included on a first digital page displayed on a user interface of a device;
receiving a first selection of a category icon from a plurality of category icons corresponding to a plurality of categories, wherein the plurality of category icons are included on the first digital page;
displaying, responsive to the selecting of the category icon, automatically and without user intervention, the object on a second digital page corresponding to a category associated with the category icon;
modifying, automatically and without user intervention, the object list to exclude the object from the first digital page;
maintaining the order of arrangement of the object list that is modified, wherein the maintaining includes displaying a second plurality of objects included in the object list that is modified on the first digital page in accordance with the order of arrangement;
receiving a second selection of a second object from the second plurality of objects in the object list that is modified, the second plurality of objects included on the first digital page; and
receiving a third selection of an additional category icon from the plurality of category icons.

18. The method of claim 17, wherein the plurality of categories include a relevant category, an irrelevant category, and a possibly relevant category.

19. The method of claim 17, further comprising:
receiving a fourth selection of an additional object from the second plurality of objects in the object list that is modified, the second plurality of objects included on the first digital page; and
receiving a fifth selection of a second category icon from the plurality of category icons.

20. The method of claim 19, further comprising further modifying the object list that is modified, the further modifying comprising excluding the additional object included in the second plurality of objects included on the first digital page.
